(19) United States
(12) Patent Application Publication
(10) Pub. No.: US 2007/0027941 A1
(43) Pub. Date: Feb. 1, 2007

(54) System, method, and service for enforcing resource utilization in a distributed system

(75) Inventors: Ralph Attila Becker-Szendy, Los Gatos, CA (US); Richard Andrew Golding, San Francisco, CA (US); Darrell D.E. Long, Soquel, CA (US)

Correspondence Address: SAMUEL A. KASSATLY LAW OFFICE, 20690 VIEW OAKS WAY, SAN JOSE, CA, 95120, US

(73) Assignee: International Business Machines Corporation

(21) Appl. No.: 11/191,777

(22) Filed: Jul. 27, 2005

(51) Int. Cl. G06F 17/30

(52) U.S. Cl. 707/205

(57) ABSTRACT

A resource utilization enforcement system enforces resource quotas in a distributed system. A bank on a central server maintains an account for each principal; the account is equivalent to a resource quota for the principal. Quotas are tracked through the use of digital coins that represent resource consumption. The bank is allowed coin generation privileges. At initiation of a computing session, a purse manager on the client accesses the account of the principal and requests coins to exchange for consumed resources. The purse manager manages the coins withdrawn in a “purse” for the principal. The purse manager submits coins to a cashier on the storage device to “purchase” storage for the principal. Refunds are provided if the storage consumption event frees storage.

### FIELD OF THE INVENTION

The present invention generally relates to a distributed computer system having a shared disk file system running on multiple computers. More specifically, the present invention relates to a method for enforcing resource utilization within a predetermined quota in the distributed computer system.

### BACKGROUND OF THE INVENTION

A distributed processing system comprises a shared disk file system operating on more than one computer. Each of the computers (also referenced as clients) in the distributed processing system comprises an instance of an operating system. Each of the clients is coupled for parallel data-sharing access to files residing on storage in the form of network attached shared disks. A user in the form of a human or an application accesses the storage through one or more clients.

To manage storage, typical distributed processing systems utilize some form of quota system that limits users to a predetermined quantity of storage. A quota is a limit, either advisory or mandatory, on how much data a user can store. Without a quota system, a user may consume all the storage on a disk, thereby denying service to others.

A conventional centralized file system such as that used by an operating system on a computer uses quota tracking to manage storage (file system space) usage of applications. This centralized quota tracking approach is further extended to a file system in which a centralized server performs block allocation. A file system using a centralized quota tracking approach is simple to implement. Enforcement is provided when the file system does not grant a write lock or a new allocation to a client when the client is over quota. However, this centralized quota tracking approach is not applicable to file systems using object-based storage devices. Furthermore, moving block allocation to a centralized server limits scalability of a distributed system.

Another conventional approach to managing storage quotas is a client-based quota-tracking system in which a distributed system tracks quota status at each of the clients. A client monitors accumulated storage usage for each of the users against a known quota assigned to each of the users. The client transmits quota status for each user to a central server in the distributed processing system. The client-based quota-tracking system can enforce a security cap that prevents writing by a client when the client exceeds a predetermined quota. However, the client-based quota-tracking system requires the storage system to inform a client how much storage is used in each storage-access event performed by a user. Further, the client-based quota-tracking system is trusted to adhere to quotas. Bugs in a client can cause quota information to become corrupted, requiring check and repair tools for quota tracking. Furthermore, the client-based quota tracking system is difficult to extend to additional clients writing against the same quota account.

Yet another conventional approach to managing storage quotas includes a physically separate quota that separates all of the domains associated with a quota into a single partition on a single storage disk and sets a quota on that partition. Each user is provided a partition on a storage disk equivalent to an allotted quota of storage space. The physically separate quota system is relatively easy to enforce. However, the physically separate quota system is difficult to extend to additional storage disks. Many partitions are required on each storage disk. Further, it is difficult to obtain current usage for the storage.

A central server is required to determine where data goes for each user. Consequently, a distributed system utilizing a physically separate quota system is inflexible with respect to changes in system configuration or quota settings. Furthermore, a physically separate quota system cannot implement independent group or user quotas.

Although conventional quota technology has proven to be useful, it would be desirable to present additional improvements. What is needed is a quota solution for a distributed processing system that can be enforced locally on a client without trusting either the client or the user and that can be used in an object-based system. Further, the quota solution should be accurate, scalable, and customizable to independent groups or users. The quota solution should be impervious to cheating and invulnerable to common mistakes made by a client or a user. Thus, there is a need for a system, a service, a computer program product, and an associated method for enforcing resource utilization in a distributed system. The need for such a solution has heretofore remained unsatisfied.

### SUMMARY OF THE INVENTION

The present invention satisfies this need, and presents a system, a service, a computer program product, and an associated method (collectively referred to herein as “the system” or “the present system”) for enforcing resource utilization in a distributed system. While the present system is described in terms of storage, it should be clear that the present system is applicable to any consumable resource such as, for example, bandwidth and I/O rates per second.

The present system comprises a bank operating on a central server, a purse manager operating on clients in the distributed system, and a cashier operating on storage devices in the distributed system. The bank maintains an account for each user (further referenced herein as a principal). A principal can be any entity such as, for example, a human or an application, that generates a storage consumption event on a storage device in the distributed system. A storage consumption event comprises any event that affects an amount of storage consumed by a principal such as, for example, a write, a delete, a clear, a truncate, etc. Enforcement of quotas by the present system is decentralized. Quotas are tracked by the purse manager through the use of digital cash or “coins”. The bank generates the coins; purse managers and principals are not allowed coin generation privileges.

Each coin represents a unit of resource usage. For a resource such as storage, each coin represents a multiple of a predetermined unit of disk storage such as, for example, 4 kB. Each coin comprises a principal ID that associates the coin with a single principal. Each coin further comprises a digital serial number and a cryptographic signature of the bank. The bank issues each coin in a denomination where the denomination represents the multiple of the predetermined unit of disk storage; i.e., 4 kB, 8 kB, 16 kB, . . . 1 GB, etc. Each coin further comprises an epoch number. The epoch number represents a time period for which the coin is valid; i.e., each coin has an expiration time.

Each principal is provided an account at the bank. The account comprises coins equivalent to a total amount of resource utilization allowed for the principal. At initiation of a computing session or a resource consumption event, the purse manager accesses the account of the principal at the bank and requests a withdrawal of coins to exchange for the resource consumed by the principal. The purse manager manages the coins withdrawn from the bank in a “purse” on behalf of the principal. The purse manager submits coins to the cashier to “purchase” storage for the principal at the initiation of a storage consumption event or at the initiation of a computing session performed by the principal. If the resource consumption event is a truncate, a delete, or a clear, the cashier does not require any coins. Any storage consumption event that clears or releases storage allocated to a principal causes the cashier to return one or more coins to the purse manager on behalf of the principal. The purse manager deposits the returned coins into the purse of the principal.

One or more coins are returned to the purse manager by the cashier if the amount of storage consumed by the principal requires fewer coins than provided by the purse manager. The purse manager is not required to determine exactly how much storage that a storage consumption event uses. The status of the account of a principal is maintained by the bank through the amount of coins remaining in the account. The bank does not issue coins to the purse manager if the purse manager requests more coins from an account than are available, preventing a principal from “overdrawing” their account. Consequently, a principal is not allowed to consume storage in excess of a predetermined storage allocation, even if the storage consumed by the principal is distributed through many different storage devices.

The purse manager locally enforces the storage quota for the principal through the use of an account stored centrally at the “bank”, providing an efficient, accurate approach to enforcing a resource quota. The present system is scalable to large distributed systems, such as tens of servers in a metadata server, or hundreds to thousands of clients in an object storage device. Further, the present system is invulnerable to common mistakes and resistant to intentional or unintentional attempts by a principal to obtain more storage than allowed.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a resource utilization enforcement system of the present invention can be used;

FIG. 2 is comprised of FIGS. 2A, 2B, and 2C, and represents a process flow chart illustrating a method of operation of the resource utilization enforcement system of FIG. 1 in obtaining and exchanging digital coins for storage on behalf of a principal; and

FIG. 3 is a process flow chart illustrating a method of operation of the resource utilization enforcement system of FIG. 1 in redeeming digital coins at the expiration of an epoch.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Digital coin: Represents a unit of resource usage. For a resource such as storage, each coin represents a multiple of a predetermined unit of disk storage such as, for example, 4 kB. Each coin comprises a principal ID that associates the coin with a single principal, a digital serial number, a denomination, an epoch number, and a cryptographic signature of the bank. The epoch number represents an epoch or a time period for which the coin is valid; i.e., each coin has a predetermined expiration time.

Storage Consumption Event: any event that affects an amount of storage consumed by a principal such as, for example, a write, a delete, a clear, a truncate, etc.

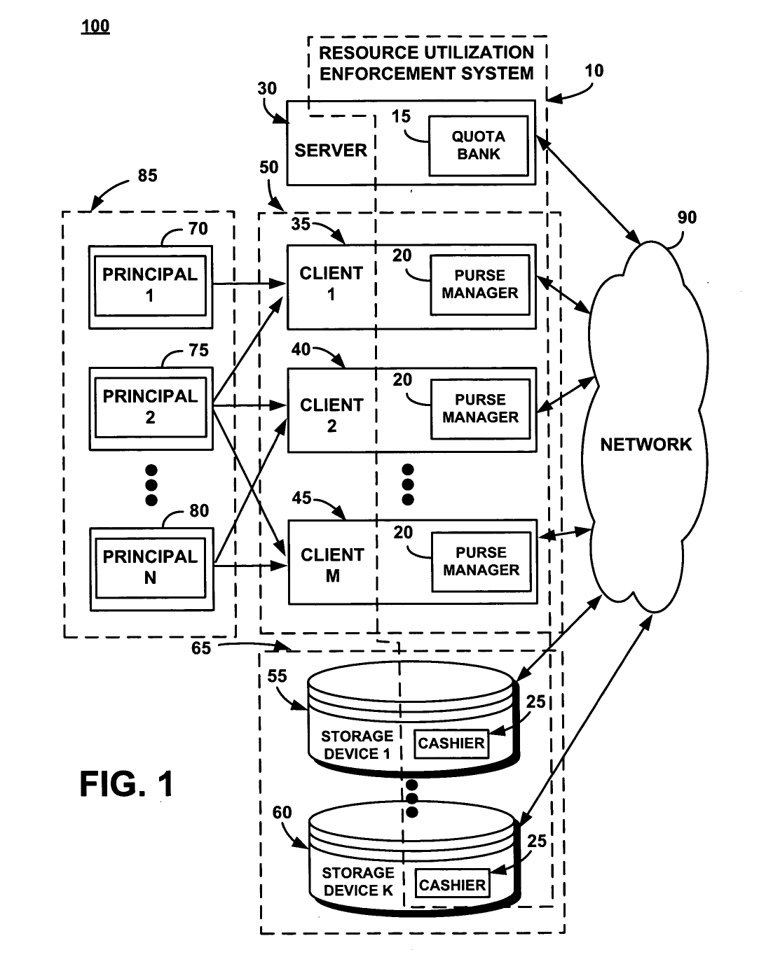

FIG. 1 portrays an exemplary overall environment in which a system, a service, a computer program product, and an associated method (the resource utilization enforcement system 10 or “the system 10”) for enforcing resource utilization in a distributed system (distributed system 100) according to the present invention may be used. System 10 comprises a quota bank 15, a purse manager 20, and a cashier 25.

System 10 includes a software programming code or computer program product that is typically embedded within or installed on a computer. The quota bank 15 is embedded within or installed on a server 30. The purse manager 20 is embedded within or installed on a computer functioning as a client server (also known as a client) such as, for example, a client 1, 35, a client 2, 40, through a client M, 45 (collectively referenced herein as clients 50). Cashier 25 is embedded within or installed on a storage device such as, for example, a storage device 1, 55, through a storage device K, 60 (collectively referenced herein as storage devices 65). Alternatively, system 10 can be saved on a suitable storage medium such as a diskette, a CD, a hard drive, or like devices.

Users such as, for example, humans or applications, are represented by a principal 1, 70, a principal 2, 75, through a principal N, 80 (collectively referenced herein as principals 85). Each of the principals 85 accesses one or more of the storage devices 65 via one or more of the clients 50. One or more of the clients 50 can act on behalf of one of the principals 85. One or more of the principals 85 can use one of the clients 50. For example, in the exemplary illustration of FIG. 1, the principal 1, 70, accesses client 1, 35; principal 2, 75, accesses client 1, 35, client 2, 40, and client M, 45; and, principal N, 80, accesses client 2, 40, and client M, 45. Clients 50 access the storage devices 65 on behalf of principals 85 via a network 90.

The quota bank 15 enforces resource utilization by use of an account (also referenced herein as a quota account) assigned to each of the principals 85; i.e., space quota usage is organized by accounts. Since files in storage have one “owning” user or principal, assignment of files to principal quotas is unambiguous. Each of the accounts comprises a quantity of digital coins (further referenced herein as coins) that represent the amount of storage allotted to each of the principals 85. Prior to participation in the distributed system 100, each of the principals 85 is provided an account at the quota bank 15 that corresponds to a storage quota. The quota bank 15 is centralized, but used infrequently compared the volume of write activity performed by the clients 50. Consequently, system 10 is scalable to large distributed systems.

An example of a distributed system 100 is a university. Each of the students, a department, a lab group, etc. receives an account that comprises storage quota. Each entity that receives a storage quota is a principal. A student (Fred) can be a principal as an individual. Fred can also be a principal in conjunction with a lab group comprising Fred and George.

For each of the principals 85 operating on a client such as client 1, 35, the purse manager 20 manages a purse. For example, the principal 1, 70, initiates a computing session in the distributed system 100 by accessing client 1, 35. The purse manager 20 on client 1, 35, requests one or more coins from the quota bank 15; the coins are used to purchase storage space from one or more of the storage devices 65. The quota bank 15 deducts the requested coins from the account of the principal 1, 70, and transfers the requested coins to the purse manager 20. The purse manager 20 on client 1, 35, places the transferred coins in a purse assigned to the principal 1, 70.

The client 1, 35, typically requests an amount of coins that allows the principal 1, 70, to perform many write commands. When the principal 1, 70, initiates usage of a client such as client 1, 35, the principal 1, 70, will have neither a purse nor coins for the purse. The exact amount of coins requested by client 1, 35, is determined by a heuristic based on a variety of factors such as, for example, an estimated number of writes that the principal 1, 70, may execute. The heuristic determines the number of coins client 1, 35, requests, how many coins the quota bank 15 issues to the client 1, 35, and when the client 1, 35, requests addition coins from the quota bank 15.

The account associated with the principal 1, 70, reflects a status of a storage quota allotted to the principal 1, 70. As the principal 1, 70, consumes storage by writing files, etc., a “balance” in the account associated with the principal 1, 70, is reduced. If insufficient “funds” remain in the account associated with the principal 1, 70, to purchase storage from one of the storage devices 65, the principal 1, 70, is denied access until the principal 1, 70, deletes items in storage or obtains a larger storage quota. The quota bank 15 can obtain additional coins for the principal 1, 70 by requesting any excess coins held by any of the clients 50 on behalf of the principal 1, 70. Access is denied to the principal 1, 70, when the quota bank 15 checks the account of the principal 1, 70, and finds insufficient funds for the requested coins. Consequently, no coins are issued to the purse manager 20 on client 1, 35, and the purse manager 20 receives an error indicating that the bank will not issue coins. The purse manager 20 cannot request storage for the principal 1, 70, from any of the storage devices 65 without coins.

If sufficient coins remain in the account of the principal 1, 70, the purse manager 20 on client 1, 35, receives the requested coins from the quota bank 15. The quota bank 15 withdraws the requested coins from the account of the principal 1, 70, and transmits the withdrawn coins to the purse manager 20 on client 1, 35. The requested coins can be provided to the purse manager 20 in various denominations. The purse manager 20 cannot modify coins or generate new coins, except for splitting the coins into smaller denominations.

Each unit value of a coin represents a predetermined amount of storage, i.e., 4 kB. Each coin comprises a denomination of the unit value of the coin such as, for example, 4 kB, 8 kB, 16 kB, . . . 1 GB, etc. A coin with denomination 100 represents 100 units of storage; i.e., 400 kB. Each coin further comprises a digital serial number, an ID for a principal (one of the principals 85) for which the coin was issued, a cryptographic signature of the quota bank 15, and an epoch number. The digital serial number uniquely identifies each coin. The selected principal is identified through a principal ID that is associated with one account of the principal. The cryptographic signature of the quota bank 15 ensures that a principal or a client cannot generate counterfeit coins.

The epoch number provides an expiration date or time for the coin. The epoch number protects a principal, for example, in the case of a client failure. For example, client 1, 35, withdraws 100 coins on behalf of the principal 1, 70. Before expending the 100 coins or returning the 100 coins to the account of the principal 1, 70, client 1, 35, fails or crashes and “loses” record of the 100 coins. At the end of each epoch, the quota bank 15 checks for coins that have expired without being spent. A value associated with coins that have expired is credited to each account because coins that have expired will not be honored by the quota bank 15. Consequently, an amount associated with the lost 100 coins is credited to the account of the principal 1, 70.

All expired coins are no longer useable; the purse manager 20 holding expired coins is required to request new coins from the quota bank 15 to replace the expired coins. Prior to expiration of a coin, principals 85 can instruct the purse manager 20 to exchange the expiring coin for a new coin with a new epoch number. When requesting coins from the quota bank 15, the purse manager 20 can specify how many coins and which denominations of coins and can also return coins that are about to expire. The purse manager 20 can further return coins to the quota bank 15 that are no longer needed; for example, a denomination of coins that the purse manager 20 will not or cannot use.

The epoch number further protects the quota bank 15 from counterfeit coins or poorly performing principals 85. Because each coin expires at the end of an epoch, the quota bank 15 is not required to maintain a history of the coin or a purse manager 20.

Each time any of the clients 50 performs a storage consumption event on behalf of any of the principals 85, the purse manager 20 transmits one or more coins along with the storage consumption request to a storage device such as storage device 1, 55. The purse manager 20 does not know in advance how much storage is required for the storage consumption event. Consequently, the purse manager 20 sends enough coins for the maximum amount of storage that the storage consumption event may use.

For example, the principal 1, 70, wishes to write a file to storage. The principal 1, 70, is using client 1, 35. The purse manager 20 on client 1, 35, contacts the quota bank, 15, and withdraws coins sufficient to purchase storage for the file. The purse manager 20 on client 1, 35, sends coins with the write request to, for example, storage device 1, 55. The storage device 1, 55, verifies the authenticity of the coins by using a key for the quota bank 15. Consequently, a client such as client 1, 35, can execute 10 operations autonomously while the quota bank 15 retains control of quota. The storage device 1, 55, writes the file to storage. If the file requires less storage than purchased by the coins, cashier 25 on storage device 1, 55, returns coins to the purse manager 20 on client 1, 35. The returned coins represent a difference between the transmitted coins and the consumed storage.

When writing to a file, each individual write operation can increase the resource usage of the file, meaning that the write operation is relevant to a quota limit of a principal such as the principal 1, 70, initiating the write. For example, if a write operation overwrites only existing data, the write operation does not increase the resource usage of the principal 1, 70. A write operation that appends new data to the end of a file increases the resource usage of the principal 1, 70, by the size of the write operation. The amount allocated by a purse manager 20 for a write operation can be anywhere between zero and the full size of the write.

Other operations are performed by any of the clients 50 that change the space resource usage of a principal such as the principal 1, 70. The principal 1, 70, can truncate a file; i.e., reduce the size of a file. The principal 1, 70, can clear parts of a file, turning existing data into a hole. The principal 1, 70, can delete a file, reducing the space usage of a file to zero. A storage consumption event comprises the write, truncate, clear, and delete operations. The storage consumption event further comprises any event that affects the amount of storage used by a principal such as the principal 1, 70.

Cashier 25 stocks coins; the stocked coins are provided by the quota bank 15. The stocked coins are transmitted to a client when a storage consumption event requires less storage than purchased by one of the clients 50 and exact change cannot be made by the cashier 25. Further, one of the principals 85 may request deletion of a file, releasing storage. For example, the principal 1, 70, instructs a client (i.e., client 1, 35) to delete a file. Client 1, 35, issues a delete command to the appropriate storage device (i.e., storage device 1, 55).

The storage device 1, 55, deletes the file. Cashier 25 on the storage device 1, 55, returns to the purse manager 20 on client 1, 35, a value in coins equivalent to the storage freed by the delete operation. The purse manager 20 on client 1, 35, deposits the returned coins in the appropriate purse maintained for the principal 1, 70.

Each coin is specific to a principal such as the principal 1, 70. In general, each coin comprises an ID for a principal (e.g., the principal 1, 70) associated with the coin. In this case, a coin is more like a debit card than cash. The purse manager 20 on client 1, 35, further deposits excess coins into the account of the principal 1, 70, in the quota bank 15.

The cashier 25 transmits accumulated coins to the quota bank 15 periodically, before the coins expire. In one embodiment, the cashier 25 returns the coins presorted according to, for example, serial number, denomination, epoch number, etc. In a further embodiment, the cashier 25 assumes some of the functions that are performed by the quota bank 15, reducing the processing performed at server 30. For example, the cashier 25 performs a serial number check on each of the coins and informs the quota bank 15 of the serial numbers missing in a series of coins returned to the quota bank 15.

An administrative tool of system 10 is used to set up a quota account for any of the principals and provide a quota of coins to the quota account. Once the quota account is generated, any operation involving obtaining or returning coins can be performed by the purse manager 20.

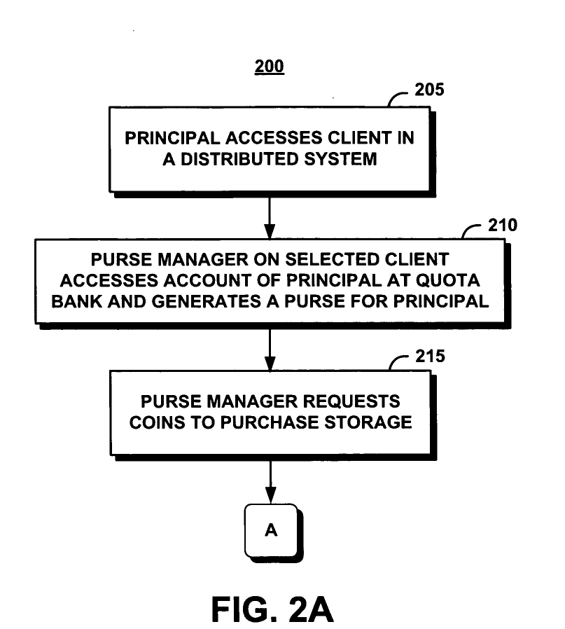

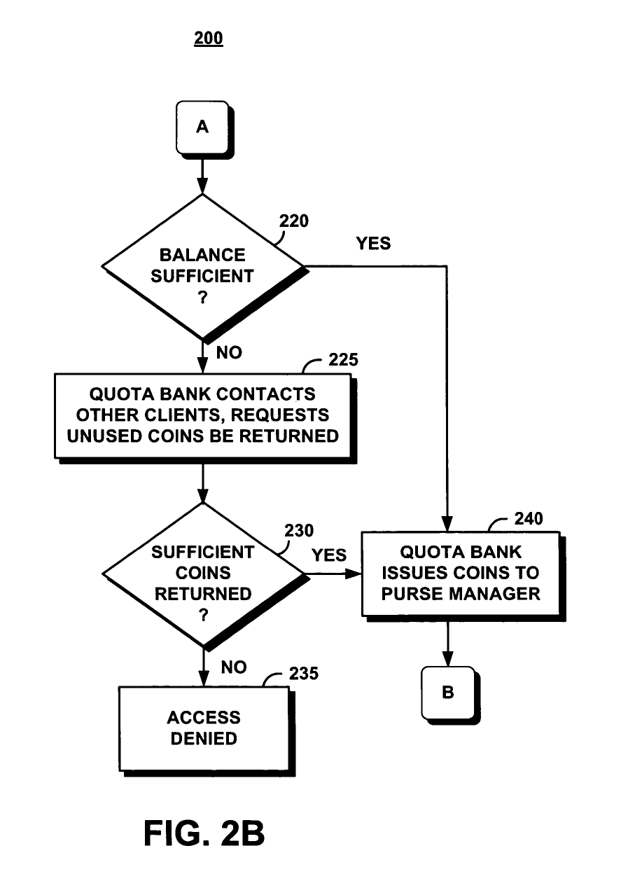

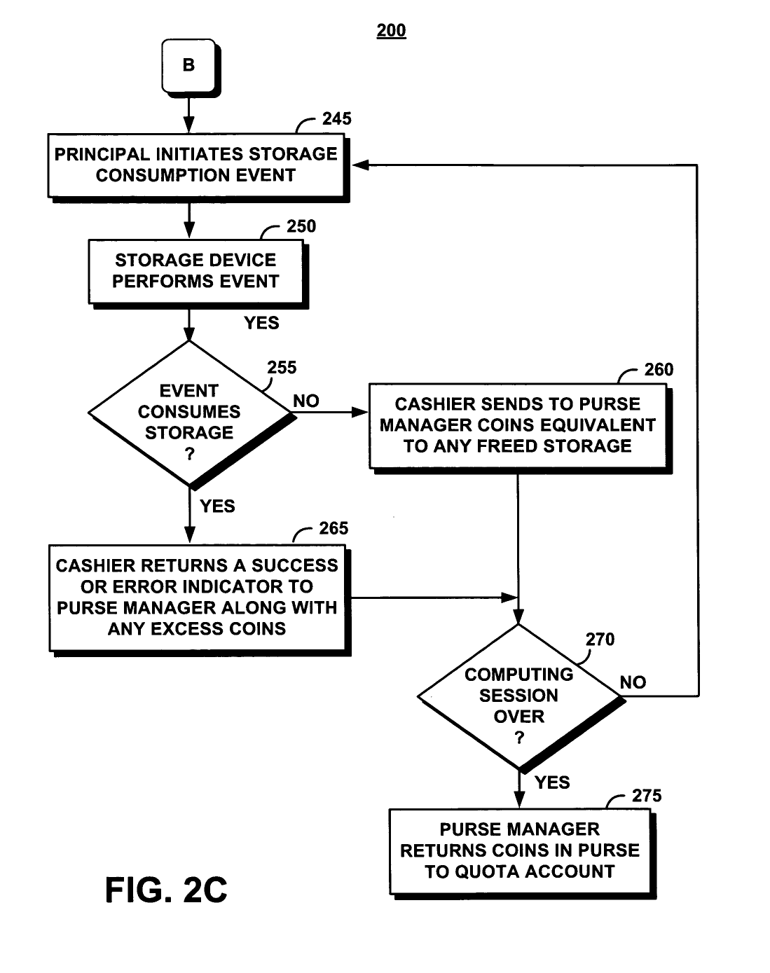

FIG. 2 (FIGS. 2A, 2B, 2C) illustrates a method 200 of system 10 in obtaining and exchanging coins for storage on behalf of a principal such as the principal 1, 70. The principal 1, 70, can interact with any of the clients 50, represented in general terms in this discussion as client 1, 35, on behalf of any of the clients 50. Similarly, client 1, 35, can interact with any of the storage devices 65, represented in general terms in this discussion as storage device 1, 55, on behalf of any of the storage devices 65.

The principal 1, 70, accesses one of the clients 50 (i.e., client 1, 35) in the distributed system 100 (step 205). The purse manager 20 on client 1, 35, generates a purse for the principal 1, 70, and accesses the account of the principal 1, 70, at the quota bank 15 (step 210). The purse manager 20 on client 1, 35, requests coins in the form of a withdrawal from the account of the principal 1, 70, at the quota bank 15 to purchase storage (step 215).

Occasionally, the quota bank 15 may be close to over-committing quota for a quota account for a principal such as the principal 1, 70. Over-committing occurs when the quota bank 15 receives more requests for coins on a quota account than the quota account is authorized to have. Over-committing can also occur when an a principal such as the principal 1, 70, is concurrently using many clients 50 while the principal 1, 70, is close to withdrawing all allotted coins from the quota bank 15. Each of the clients 50 being used by the principal 1, 70, will request a sufficient number of coins to cover the likely storage consumption events of the principal 1, 70. At some point, one of the clients 50 may request coins that cannot be issued by the quota bank 15 because the request overdraws the quota account of the principal 1, 70.

The quota bank 15 determines whether the balance in the account of the principal 1, 70, is sufficient for the requested withdrawal (decision step 220). If the balance is not sufficient, the quota bank 15 contacts any of the clients 50 that are currently holding coins on behalf the quota account of the principal 1, 70, requesting that the purse manager 20 on those clients 50 return any unused coins associated with the quota account of the principal 1, 70 (step 225). This request is a recall request. Typically, the purse manager 20 on each of the clients 50 will quickly return as many coins as can be spared to the quota account of the principal 1, 70.

In one embodiment, a communication protocol between the quota bank 15 and the purse manager 20 comprises a return message requiring the clients 50 that are holding coins on behalf of the principal 1, 70, to acknowledge the request. In another embodiment, a lease is used to require a client such as client 1, 35, to respond to a recall request within a predetermined time. If a recall request is not honored, the quota bank 15 responds with an appropriate action such as, for example, forcing an epoch transition, etc., to prevent the “rogue” client from using coins in an unauthorized fashion and to free coins to honor the request of step 215.

The quota bank 15 determines whether sufficient coins have been returned to the quota account for the principal 1, 70 (decision step 230). If, in decision step 230, sufficient coins are not returned, access is denied to the principal 1, 70 (step 235). If sufficient coins have been returned to the quota account for the principal 1, 70, the quota bank issues coins to the purse manager 20 on client 1, 35 (step 240). If, in decision step 220, the balance in the account of the principal 1, 70, is sufficient for the request by the purse manager 20 on client 1, 35, the quota bank 15 issues coins to the purse manager 20 on client 1, 35, (step 240).

The principal 1, 70, initiates a storage consumption event (further referenced herein as an event) (step 245). The storage device 1, 55, performs the specified storage consumption event (step 250). If the storage consumption event does not consume storage (decision step 255), no coins are required for the specified storage consumption event. Cashier 25 on the storage device 1, 55, sends to the purse manager 20 on client 1, 35, coins equivalent to the freed storage, if any storage is freed by the specified storage consumption event (step 260); the returned coins are placed in the purse of the principal 1, 70.

If the specified storage consumption event consumes storage (decision step 250), the purse manager 20 is required to furnish sufficient coins to the cashier 25 on the storage device 1, 55, to pay for additional space usage caused by the storage consumption event. If the client 1, 35, is in doubt whether the storage consumption event will be allocating, the purse manager 20 on client 1, 35, submits enough coins to the cashier 25 on the storage device 1, 55, to pay for a total length of the data payload (i.e., the largest possible amount of space required for the storage consumption event).

Cashier 25 on the storage device 1, 55, returns any excess coins from the specified storage consumption event to the purse manager 20 on client 1, 35 (step 265). The cashier 25 further returns a success or error indicator to the purse manager 20 on the client 1, 35. A success indicator informs the purse manager 20 that the storage consumption event occurred successfully. An error indicator informs the purse manager 20 that an error occurred in the transaction between the purse manager 20 on the client 1, 35, and the cashier 25 on the storage device 1, 35. Possible errors comprise the purse manager 20 submitting an expired coin, the purse manager 20 attempted to spend a coin that has already been spent, the purse manager submitted insufficient coins, etc.

If the computing session is over (decision step 270), the purse manager 20 on client 1, 35, returns coins in the purse of the principal 1, 70, to the quota account of the principal 1, 70, at the quota bank 15 (step 275). If the computing session is not over (decision step 270), processing returns to step 245 in which the principal 1, 70, may initiate another storage consumption event.

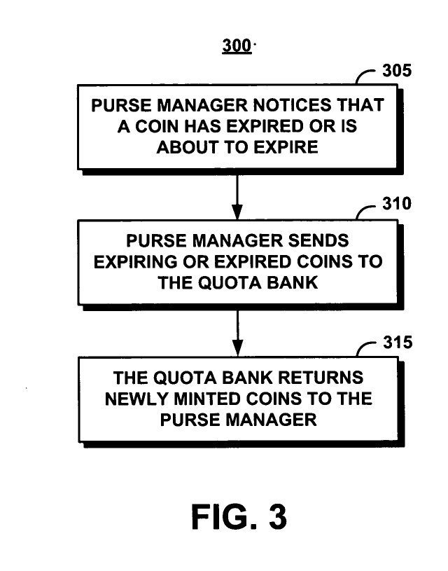

FIG. 3 illustrates a method 300 of system 10 in managing coins when an epoch expires. Each coin comprises an expiration date corresponding to an epoch. The purse manager 20 notices that a coin has expired or is about to expire (step 305). The purse manager 20 sends the expiring or expired coins to the quota bank 15 (step 310). The quota bank 15 returns newly minted coins to the requesting purse manager 20.

In one embodiment, storage consumption by a file can be allotted to one or more accounts in the quota bank 15. For example, a principal that is a user and a principal that is a group may own a file in storage. In this embodiment, whichever quota is first exceeded stops further allocation to either the user or the group. In general, there may be one or more dimensions of accounts in the quota bank 15. Further, each file in storage can have one account for each dimension. In comparison, a conventional quota approach limits a file to one (user quota) or two (user and group quota) dimensions.

If any of the storage devices 65 fail (e.g., the storage device 1, 55), server 30 updates the file structure of the distributed file system 100 to mark files as unreachable or damaged. The quota bank 15 then updates quota accounts associated with the storage device 1, 55, to reflect space usage that no longer exists. If the storage device 1, 55, fails temporarily, server 30 adjusts quota accounts to reflect space usage when the storage device 1, 55, is restored.

Coins can be issued to the clients 50 on, for example, a lease basis. If one of the clients 50 fail (e.g., the client 1, 35), the quota bank 15 knows which coins were held by the purse manager 20 on the failed client 1, 35. The quota bank 15 can retrieve the unused coins. The quota bank 15 can further reconcile the quota account of the principals 85 with cashier 25 on each of the storage devices 65 to determine how many of the coins held by the client 1, 35, had been spent.

System 10 ensures that the clients 50 co not spend the same coin twice at the same cashier 25. The cashier 25 records serial numbers for the coins received from the purse manager 20 on each of the clients 50. Any of the clients 50 may attempt to spend the same coin more than once at a cashier 25 on more than one of the storage devices 65. This improper use of a coin is detected when the cashier 25 returns coins to the quota bank 15. The quota bank 15 identifies duplicate coins, adjusting the quota account of any of the principals 85 as needed.

It is to be understood that the specific embodiments of the invention that have been described are merely illustrative of certain applications of the principle of the present invention. Numerous modifications may be made to the system, method, and service for enforcing resource utilization in a distributed system described herein without departing from the spirit and scope of the present invention. Moreover, while the present invention is described for illustration purpose only in relation to storage, it should be clear that the invention is applicable as well to, for example, to any consumable resource such as bandwidth, etc.

What is claimed is:

1. A method of enforcing resource utilization in a distributed system, comprising:
maintaining a quota account for a principal in a quota bank;
withdrawing digital coins from the quota bank on behalf of the principal;
exchanging the digital coins for resources; and
wherein the quota bank monitors resource usage of the principal by monitoring a balance in the quota account of the principal.

2. The method of claim 1, further comprising storing the digital coins in a purse associated with the principal.

3. The method of claim 1, further comprising denying access by the principal to the resource if the balance is insufficient.

4. The method of claim 1, wherein maintaining the quota comprises maintaining a single quota account per principal.

5. The method of claim 4, wherein maintaining the quota bank is centrally located.

6. The method of claim 1, wherein withdrawing the digital coins comprise maintaining a balance in the quota account that is sufficient to cover the digital coins.

7. The method of claim 6, wherein if the balance is insufficient and resources are not freed, the principal is denied access.

8. The method of claim 7, wherein the digital coins represent a predetermined unit of resource usage.

9. The method of claim 7, wherein the digital coins comprise a principal identification that associates the digital coins with a single principal.

10. The method of claim 7, wherein the digital coins comprise a digital serial number that uniquely identifies the digital coins.

11. The method of claim 7, wherein the digital coins comprise a cryptographic signature of the bank.

12. The method of claim 7, wherein the digital coins comprise at least one denomination.

13. The method of claim 7, wherein the digital coins comprise an epoch number that define an expiration period.

14. The method of claim 13, wherein expired digital coins are not honored by the bank.

15. The method of claim 2, further comprising returning the digital coins to the bank at the end of a computing session.

16. The method of claim 15, wherein the purse is not persistent.

17. The method of claim 1, wherein exchanging the digital coins comprises transferring the digital coins to purchase at least some of the resources.

18. The method of claim 17, further comprising returning the digital coins that exceed a cost of a resource.

19. The method of claim 18, further comprising refunding coins to a client as resource are freed.

20. A system for enforcing resource utilization in a distributed system, comprising:
a quota bank for maintaining a quota account for a principal;
a purse manager for withdrawing digital coins from the quota bank on behalf of the principal;
a cashier for performing a transaction with the purse manager to exchange the digital coins for resources; and
wherein the quota bank monitors resource usage of the principal by monitoring a balance in the quota account of the principal.

21. A computer program product having a plurality of executable codes stored on a computer-readable medium, for enforcing resource utilization in a distributed system, comprising:
a first set of instruction codes for maintaining a quota account for a principal;
a second set of instruction codes for withdrawing digital coins on behalf of the principal;
a third set of instruction codes for exchanging the digital coins for resources; and
a fourth set of instruction codes for monitoring resource usage of the principal by monitoring a balance in the quota account of the principal.
